(19) United States
(12) Patent Application Publication
(10) Pub. No.: US 2010/0245242 A1
(43) Pub. Date: Sep. 30, 2010

(54) ELECTRONIC DEVICE AND METHOD FOR OPERATING SCREEN

(76) Inventors: Yi-Hsi WU, Taipei City (TW); Huang-Ming Chang, Taipei City (TW); Yu-Jen Huang, Taipei City (TW); Hong-Tien Wang, Taipei City (TW)

Correspondence Address: Muncy, Geissler, Olds & Lowe, PLLC, 4000 Legato Road, Suite 310, FAIRFAX, VA, 22033, US

(21) Appl. No.: 12/751,220

(22) Filed: Mar. 31, 2010

Related U.S. Application Data
(60) Provisional application No. 61/164,918, filed on Mar. 31, 2009.

(51) Int. Cl. G09G 5/08

(52) U.S. Cl. 345/157

(57) ABSTRACT

An electronic device and a method of operating a screen are disclosed; the touch screen has a display area and a non-display area, and the method includes steps as follows. First, a first sensing signal is generated when a designator controls a pointer on the non-display area. Then, a second sensing signal is generated when the pointer is moved from the non-display area to the display area. Then, a third sensing signal is generated when the pointer is moved on the display area. Last, a user interface is opened in the display area when a processing module receives the first, second and third sensing signals sequentially.

### RELATED APPLICATIONS

This application claims priority to U.S. Provisional Application Ser. No. 61/164,918, filed Mar. 31, 2009, which is herein incorporated by reference.

### BACKGROUND

1. Technical Field

The present disclosure relates to an electronic device and a method of operating a screen.

2. Description of Related Art

With the fast development of the electronics industry and information technology, electronic products have become more popular. Conventionally, many electronic devices, such as computers or mobile phones, have screens.

As to a small electronic device, its the touch screen is limited in size. A user comes to grips with the touch screen, so that errors in operation are extremely common. In view of the foregoing, there is an urgent need in the related field to provide a way to operate the screen ergonomically.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to an electronic device and a method of operating a screen.

According to one embodiment of the present invention, the electronic device includes a screen and a processing module. The screen has the display area and the non-display area. When a designator controls a pointer on the non-display area, a first sensing signal is generated; when the pointer is moved from the non-display area to the display area, a second sensing signal is generated; when the pointer is moved on the display area, a third sensing signal is generated. When receiving the first, second and third sensing signals that are sequentially generated by the screen, the processing module opens a user interface in the display area.

When using the electronic device, a user can makes the pointer move to the non-display area and then move to the display area for opening the user interface. This operating mode conforms to ergonomics; thereby errors in operation are reduced.

According to another embodiment of the present invention, the screen has a display area and a non-display area, and the method for operating the screen includes following steps:

(a) When a designator controls a pointer on the non-display area, a first sensing signal is generated;

(b) When the pointer is moved from the non-display area to the display area, a second sensing signal is generated;

(c) When the pointer is moved on the display area, a third sensing signal is generated; and

(d) When a processing module sequentially receives the first, second, and third sensing signals generated by the screen, a user interface is opened in the display area.

When performing the method for operating the screen, a user can makes the pointer move to the non-display area and then move to the display area for opening the user interface. Moreover, the screen may be a touch screen or a non-touch screen. This mode of operating the screen conforms to the user's intuition, so as to provide convenience to operation.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of an electronic device according to one or more embodiments of the present invention;

FIG. 2, FIG. 3, FIG. 4, FIG. 5 and FIG. 6 are schematic drawings of operating states of the electronic device of FIG. 1, respectively;

FIG. 7A and FIG. 7B are block diagrams of the electronic device of FIG. 1, respectively; and

FIG. 8 is a flowchart of a method for operating a screen according to one or more embodiments of the present invention.

### DETAILED DESCRIPTION

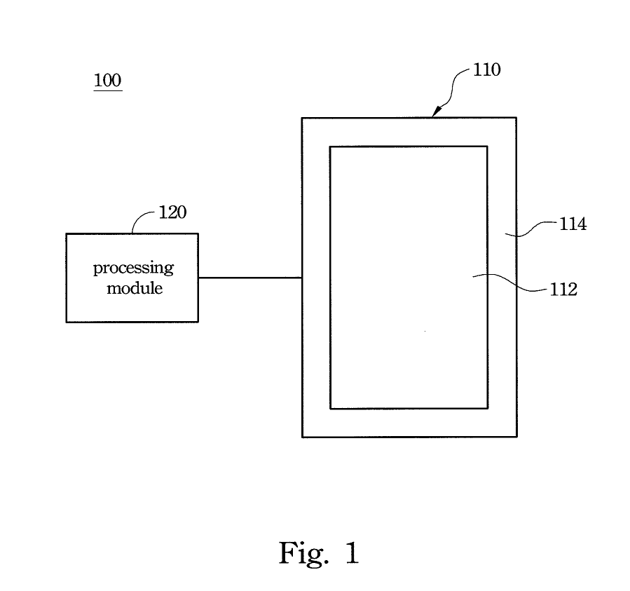

FIG. 1 is a block diagram of an electronic device 100 according to one or more embodiments of the present invention. As shown in FIG. 1, the electronic device 100 comprises the screen 110 and the processing module 120. The screen 110 may be a non-touch screen, such as an liquid crystal display, a cathode ray tube (CRT) or the like; alternatively, the screen 110 may be a touch screen, such as a touch interface CRT screen, a touch panel display apparatus, an optical screen or the like.

The screen 110 has a display area 112 and a non-display area 114. The non-display area 114 is disposed outside the display area 112. In use, the display area 112 can display frames; the non-display area 114 is not necessary to or unable to display the frames.

In the following embodiments, the screen 110 is the touch screen, and the designator 140 is a user's finger. Those skilled in the art will appreciate that the touch screen and the user's finger are illustrative only and is NOT intended to be in any way limiting. For example, the designator 140 may be an entity or a stylus if the screen 110 is the touch screen. In use, the touch screen senses that the entity or the stylus touches thereon and thereby controls a pointer's movement. Moreover, the pointer is not necessary to display a graphic cursor on the screen 110. For example, the designator 140 may be a mouse or a touch pad if the screen 110 is the non-touch screen; alternatively, an image capture apparatus captures the user's gesture to analyze image variation to generate a control signal for controlling the pointer's movement. Moreover, the non-display area 114 may be an outline border if the screen 110 is a non-touch screen. It is determined that designator 140 controls the pointer's movement by determining whether the graphic cursor is displayed in the display area 112.

When a designator 140 controls a pointer on the non-display area 114, t a first sensing signal is generated; when the pointer is moved from the non-display area 114 to the display area 112, a second sensing signal is generated; when the pointer is moved on the display area 112, a third sensing signal is generated. When receiving the first, second and third sensing signals that are sequentially generated by the screen 110, the processing module 120 opens a user interface in the display area 112.

In this way, when using the electronic device, a user can makes the pointer move to the non-display area and then move to the display area for opening the user interface. This operating mode conforms to the user's intuition, so as to provide convenience to operation.

Specifically, the processing module 120 commands the display area 112 to display a menu based on the first sensing signal. The menu has at least one the item. The form of the item may be an icon, characters or the combinations thereof, so as to facilitate the user to view.

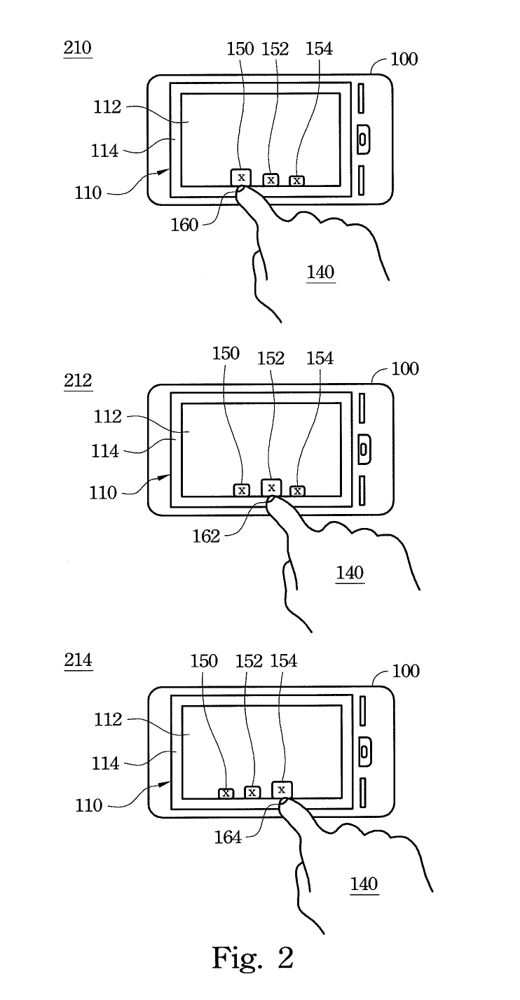

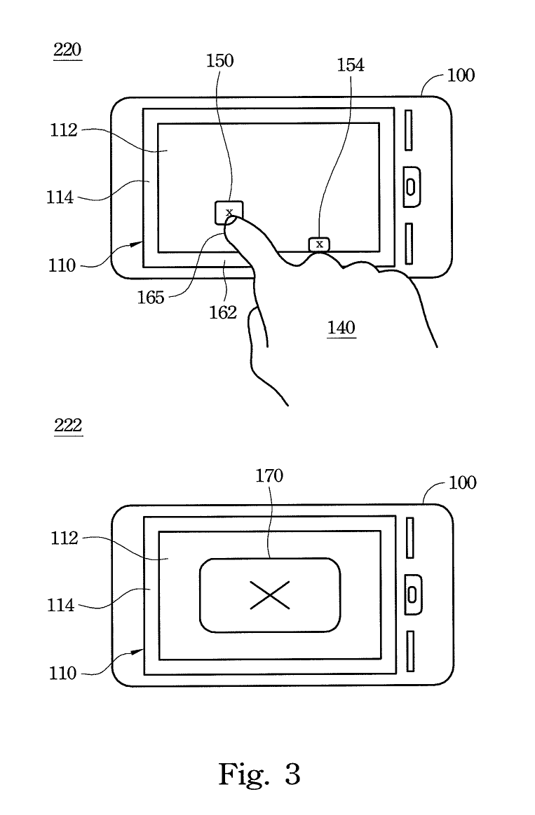

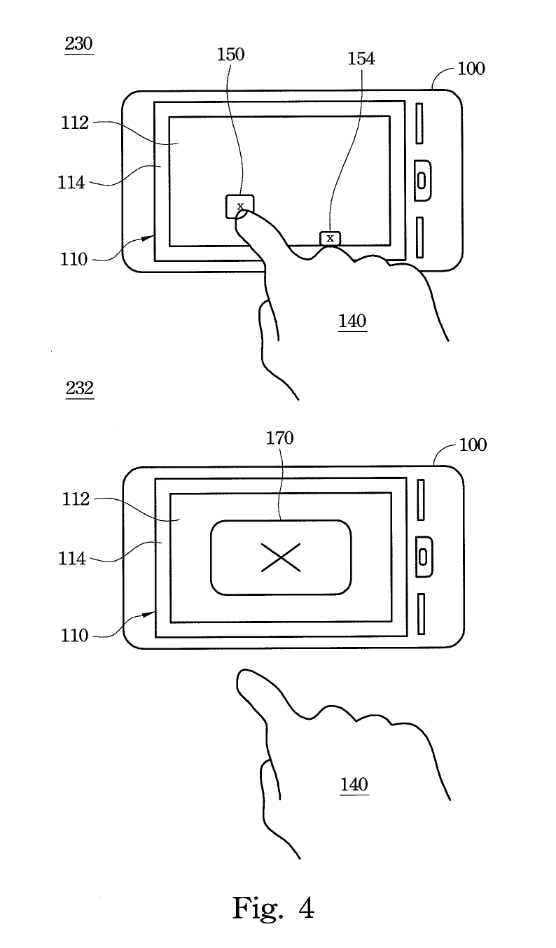

As shown in FIG. 2, the display area 112 displays a plurality of items 150, 152, 154 when the designator 140 controls the pointer on the non-display area 114. In the operating state 210, the processing module 120 selects the item 150 that is mostly close to the pointer's position 160 and enlarges the item 150. In the operating state 212, the processing module 120 selects the item 152 that is mostly close to the pointer's position 162 and enlarges the item 152. The pointer is moved from the position 160 to the neighboring position 162 sequentially. In the operating state 214, the pointer is slid from the position 160 to the position 164 to select item 154 or directly contacts the position 164 to select item 154.

When the pointer is moved from the non-display area 114 to the display area 112, a second sensing signal is generated. In this way, the pointer's movement from the non-display area 114 to the display area 112 is considered indeed, so as to reduce the probability of erroneous determination of the screen 110.

The items 150, 152, 154 are corresponding to different user interfaces respectively. For a more complete understanding of opening the user interface, please refer following first, second, third and fourth embodiments.

### First Embodiment

As shown in FIG. 1, the first sensing signal is generated when a designator 140 controls a pointer on the non-display area 114. The processing is module 120 commands the display area 112 to display a menu based on the first sensing signal. The menu has at least one the item. The screen 110 presets at least one trigger position corresponding to a place that the item is displayed. When the designator 140 is moved from the non-display area 114 to the display area 112, the second sensing signal is generated for confirming the user's motion. When the designator 140 is moved on the display area 112 and touches the trigger position, the third sensing signal is generated. When receiving the first, second and third sensing signals that are sequentially generated by the screen 110, the processing module 120 opens the user interface corresponding to the item in the display area 112.

As shown in FIG. 3, in the operating state 220, the first sensing signal is generated when the designator 140 touches the position 162 in the non-display area 114; the display area 112 renders a menu containing items 150 and 154. Then, the second sensing signal is generated when the designator 140 is moved from the position 162 of the non-display area 114 to the display area 112. Then, the third sensing signal is generated when the designator 140 is moved on the trigger position 165 in the display area 112. In the operating state 222, the display area 112 renders the user interface 170 corresponding to the item 150.

### Second Embodiment

As shown in FIG. 1, the first sensing signal is generated when a designator 140 controls a pointer to move to the non-display area 114. The processing module 120 commands the display area 112 to display a menu based on the first sensing signal. The menu has at least one the item. When the designator 140 is moved from the non-display area 114 to the display area 112, the second sensing signal is generated. Then, the third sensing signal is generated when the designator 140 drags the item on the display area 112 and then moves away from the screen 110. When receiving the first, second and third sensing signals that are sequentially generated by the screen 110, the processing module 120 opens the user interface corresponding to the item in the display area 112.

As shown in FIG. 4, in the operating state 230, the first sensing signal is generated when the designator 140 touches the non-display area 114; the display area 112 renders a menu containing items 150 and 154. Then, the second sensing signal is generated when the designator 140 is moved from the non-display area 114 to the display area 112. Then, the third sensing signal is generated when the designator 140 drags the item 150 on the display area 112 and then release from the item 150. In the operating state 232, the display area 112 renders the user interface 170 corresponding to the item 150.

### Third Embodiment

As shown in FIG. 1, the first sensing signal is generated when a designator 140 controls a pointer on the non-display area 114. The processing module 120 commands the display area 112 to display a menu based on the first sensing signal. The menu has at least one the item. Then, the second sensing signal is generated when the designator 140 is moved from the non-display area 114 to the display area 112. Then, the third sensing signal is generated when the designator 140 continuously drags the item on the display area 112 and changes directions of dragging the item. When receiving the first, second and third sensing signals that are sequentially generated by the screen is 110, the processing module 120 opens the user interface corresponding to the item in the display area 112.

In practice, when the designator 140 drags the item in a first direction and turns to a second direction, and when an included angle between the first and second directions is larger than 90°, the third sensing signal is generated. If the included angle is less than 90°, the designator 140 may move back on the non-display area 114; this motion signifies the user doesn't want to open the user interface corresponding to the item. Therefore, the included angle being larger than 90° conforms to ergonomics, so as to facilitate operation.

As shown in FIG. 5, in the operating state 240, the first sensing signal is generated when the designator 140 touches the non-display area 114; the display area 112 renders a menu containing items 150 and 154. Then, the second sensing signal is generated when the designator 140 is moved from the non-display area 114 to the display area 112. When the designator 140 moves toward a directions 180 that is from the non-display area 114 to the display area 112 and then moves toward another directions 182 in the display area 112, the user interface (not shown) is rendered in the display area 112.

### Fourth Embodiment

As shown in FIG. 1, the first sensing signal is generated when a designator 140 controls a pointer on the non-display area 114. The processing module 120 commands the display area 112 to display a menu based on the first sensing signal. The menu has at least one the item. Then, the second sensing signal is generated when the designator 140 is moved from the non-display area 114 to the display area 112. Then, the third sensing signal is generated when the designator 140 drags the item on the display area 112 and then ceases moving the item over a predetermined period. When receiving the first, second and third sensing signals that are sequentially generated by the screen 110, the processing module 120 opens the user interface corresponding to the item in the display area 112.

The predetermined period may be 2 seconds. If the predetermined period is less than 2 seconds, the user may be in a flurry according to human's reaction to operation. Alternatively, the predetermined period may be greater than 2 seconds; however, it is waste time if he predetermined period is too long.

As shown in FIG. 6, in the operating state 250, the first sensing signal is generated when the designator 140 touches the non-display area 114; the display area 112 renders a menu containing items 150, 152 and 154. Then, the second sensing signal is generated when the designator 140 is moved from the non-display area 114 to the display area 112. Then, the third sensing signal is generated when the designator 140 drags the item 152 to the position 166 of the display area 112 and cease moving the item for a period. In the operating state 252, the display area 112 renders the user interface 170 corresponding to the item 150.

In view of above, technical advantages are generally achieved, by embodiments of the present invention, as follows:

1. The menu is opened by means of moving the pointer on the to non-display area 114, so that the display area 112 is not affected; and

2. The user interface corresponding to the item is opened by means of dragging the item, so that the user can intuitively select the user interface.

The processing module 120 may be hardware, software, and/or firmware. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

In the screen 110, the display area 112 and the non-display area 114 share the same touch sensor; alternatively, the display area 112 and the non-display area 114 utilize different touch sensors.

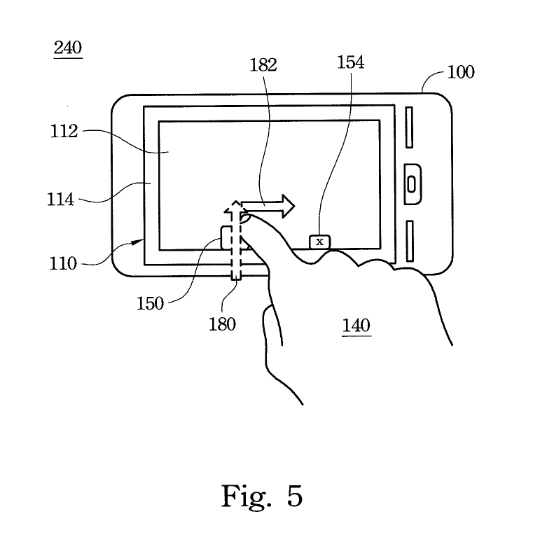

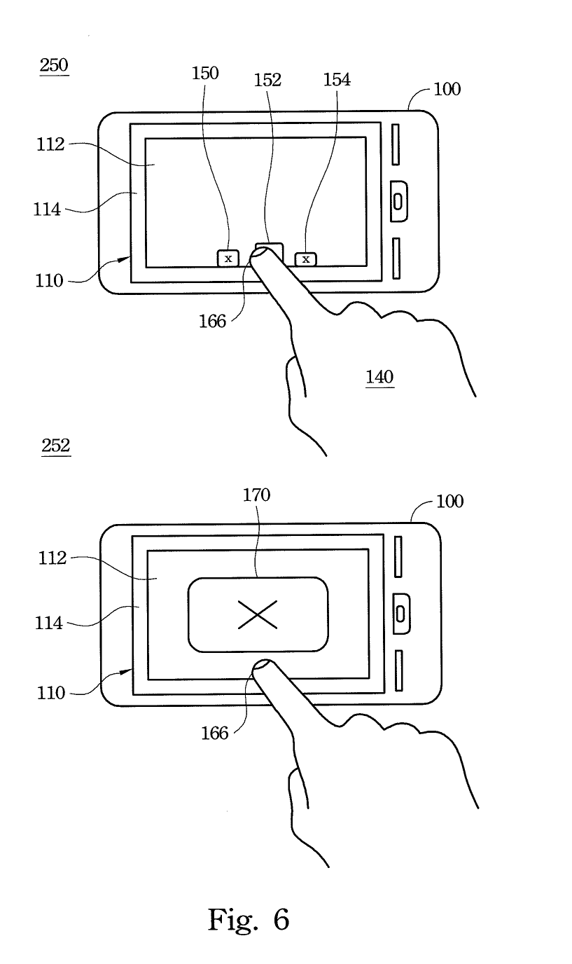

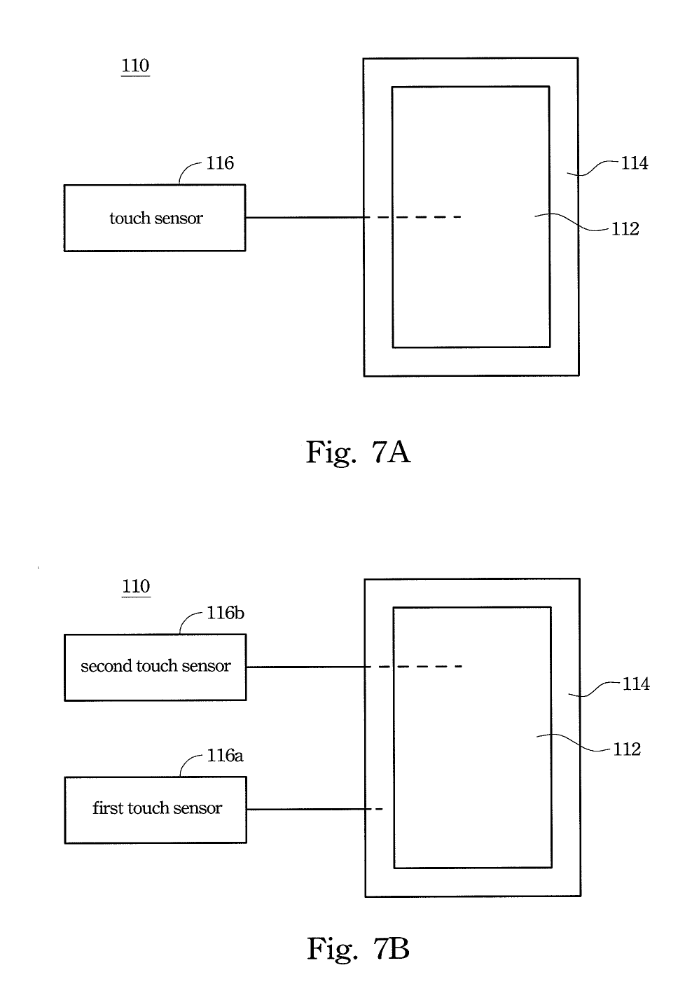

As shown in FIG. 7A, the screen 110 has a touch sensor 116 for sensing the designator's motion for the screen 110. The display area 112 and the non-display area 114 share the same touch sensor 116. The touch sensor 116 generates the first sensing signal when the designator's motion is to touch the non-display area 114; The touch sensor 116 generates the second sensing signal when the designator is moved from the non-display area 114 to the display area 112; the touch sensor 116 generates the third sensing signal when the designator is moved on the display area 112.

As shown in FIG. 7B, the screen 110 has a first touch sensor 116a for sensing the designator's motion for the non-display area 114 and a second touch sensor 116b for sensing the designator's motion for the display area 112. The first touch sensor 116a is separated from the second touch sensor 116b. The first touch sensor 116a generates the first sensing signal when the designator's motion is to touch the non-display area 114; the first or second touch sensor 116a or 116b generates the second sensing signal when the designator is moved from the non-display area to the display area; the second touch sensor 116b generates the third sensing signal when the designator is moved on the display area 112.

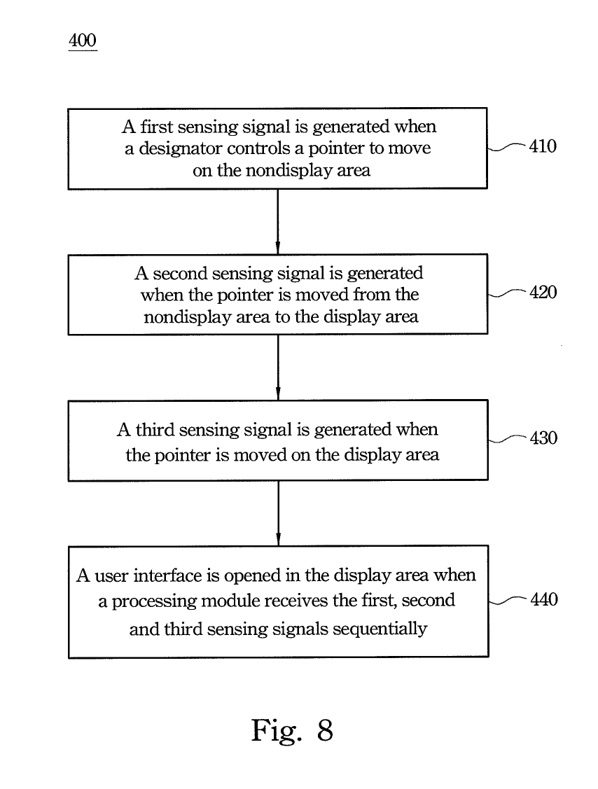

FIG. 8 is a flowchart of a method 400 for operating a screen according to one or more embodiments of the present invention. The screen has a display area and a non-display area, and the method 400 comprises steps 410˜440 as follows (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 410, a first sensing signal is generated when a designator controls a pointer on the non-display area. In step 420, a second sensing signal is generated when the pointer is moved from the non-display area to the display area. In step 430, a third sensing signal is generated when the pointer is moved on the display area. In step 440, a user interface is opened in the display area when a processing module sequentially receives the first, second and third sensing signals generated by the screen.

When performing the method 400, a user can makes the pointer move to the non-display area and then move to the display area for opening the user interface. The method 400 conforms to the user's ergonomics, so as to reduce the probability of errors in operation.

For a more complete understanding of opening the user interface, please refer following first, second, third and fourth operating modes.

In the first operating mode, a first sensing signal is generated when a designator touches the non-display area. In step 410, the display area is commanded to display a menu based on the first sensing signal, wherein the menu has at least one the item. In step 420, a second sensing signal is generated when the pointer is moved from the non-display area to the display area. In step 430, at least one trigger position is preset corresponding to a place that the item is displayed, and generating the third sensing signal when the designator touches the trigger position. In step 440, the user interface corresponding to the item is opened in the display area.

In the second operating mode, a first sensing signal is generated when a designator touches the non-display area. In step 410, the display area is commanded to display a menu based on the first sensing signal, wherein the menu has at least one the item. In step 420, a second sensing signal is generated when the pointer is moved from the non-display area to the display area. In step 430, the third sensing signal is generated when the designator drags the item on the display area and then moves away from the screen. In step 440, the user interface corresponding to the item is opened in the display area.

In the third operating mode, a first sensing signal is generated when a designator touches the non-display area. In step 410, the display area is commanded to display a menu based on the first sensing signal, wherein the menu has at least one the item. In step 420, a second sensing signal is generated when the pointer is moved from the non-display area to the display area. In step 430, the third sensing signal is generated when the designator area continuously drags the item on the display and changes directions of dragging the item. Specifically, when the designator drags the item in a first direction and turns to a second direction, and when an included angle between the first and second directions is larger than 90°, the third sensing signal is generated. In step 440, the user interface corresponding to the item is opened in the display area.

If the included angle is less than 90°, the designator 140 may move back on the non-display area 114; this motion signifies the user doesn't want to open the user interface corresponding to the item. Therefore, the included angle being larger than 90° conforms to ergonomics, so as to facilitate operation.

In the fourth operating mode, a first sensing signal is generated when a designator touches the non-display area. In step 410, the display area is commanded to display a menu based on the first sensing signal, wherein the menu has at least one the item. In step 420, a second sensing signal is generated when the pointer is moved from the non-display area to the display area. In step 430, the third sensing signal is generated when the designator drags the item on the display area and then ceases moving the item over a predetermined period. In step 440, the user interface corresponding to the item is opened in the display area.

The predetermined period may be 2 seconds. If the predetermined period is less than 2 seconds, the user may be in a flurry according to human's reaction to operation. Alternatively, the predetermined period may be greater than 2 seconds; however, it is waste time if he predetermined period is too long.

The method 400 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. An electronic device, comprising:
a screen having a display area and a non-display area, wherein when a designator controls a pointer on the non-display area, a first sensing signal is generated, when the pointer is moved from the non-display area to the display area, a second sensing signal is generated, and when the pointer is moved on the display area, a third sensing signal is generated; and
a processing module for receiving the first, second and third sensing to signals that are sequentially generated by the screen to open a user interface in the display area.

2. The electronic device of claim 1, wherein the processing module commands the display area to display a menu based on the first sensing signal, wherein the menu has at least one the item.

3. The electronic device of claim 2, wherein the screen presets at least one trigger position corresponding to a place that the item is displayed, when the designator touches the trigger position, the third sensing signal is generated, so that the processing module for opening the user interface corresponding to the item in the display area.

4. The electronic device of claim 2, wherein when the designator drags the item on the display area and then moves away from the screen, the third sensing signal is generated, so that the processing module opens the user interface corresponding to the item in the display area.

5. The electronic device of claim 2, wherein when the designator continuously drags the item on the display area and changes directions of dragging the item, the third sensing signal is generated, so that the processing module opens the user interface corresponding to the item in the display area.

6. The electronic device of claim 5, wherein when the designator drags the item in a first direction and turns to a second direction, and when an included angle between the first and second directions is larger than 90°, the third sensing signal is generated.

7. The electronic device of claim 2, wherein when the designator drags the item on the display area and then ceases moving the item over a predetermined period, the third sensing signal is generated, so that the processing module opens the user interface corresponding to the item in the display area.

8. The electronic device of claim 7, wherein the predetermined period is 2 seconds.

9. The electronic device of claim 1, wherein the screen has a touch sensor for sensing the designator's motion for the screen, and the display area and the non-display area share the touch sensor, the touch sensor for generating the first sensing signal when the designator's motion is to touch the non-display area, the touch sensor for generating the second sensing signal when the designator is moved from the non-display area to the display area, and the touch sensor for generating the third sensing signal when the designator is moved on the display area.

10. The electronic device of claim 1, wherein the screen has a first touch sensor for sensing the designator's motion for the non-display area and a second touch sensor for sensing the designator's motion for the display area, the first touch sensor is separated from the second touch sensor, the first touch sensor for generating the first sensing signal when the designator's motion is to touch the non-display area, the first or second touch sensor for generating the second sensing signal when the designator is moved from the non-display area to the display area, and the second touch sensor for generating the third sensing signal when the designator is moved on the display area.

11. A method for operating the screen, the screen having a display area and a non-display area, the method comprising:
(a) generating a first sensing signal when a designator controls a pointer on the non-display area;
(b) generating a second sensing signal when the pointer is moved from the non-display area to the display area;
(c) generating a third sensing signal when the pointer is moved on the display area; and
(d) opening a user interface in the display area when a processing module sequentially receives the first, second and third sensing signals generated by the screen.

12. The method of claim 11, wherein the step (a) comprises:
commanding the display area to display a menu based on the first sensing signal, wherein the menu has at least one the item.

13. The method of claim 12, wherein the step (c) comprises:
presetting at least one trigger position corresponding to a place that the item is displayed, and generating the third sensing signal when the designator touches the trigger position, the step (d) comprises:
opening the user interface corresponding to the item in the display area.

14. The method of claim 12, wherein the step (c) comprises:
generating the third sensing signal when the designator drags the item on the display area and then moves away from the screen, the step (d) comprises:
opening the user interface corresponding to the item in the display area.

15. The method of claim 12, wherein the step (c) comprises:
generating the third sensing signal when the designator area continuously drags the item on the display and changes directions of dragging the item, the step (d) comprises:
opening the user interface corresponding to the item in the display area.

16. The method of claim 15, wherein the step (c) comprises:
when the designator drags the item from a first direction and turns to a second direction, and when an included angle between the first and second directions is larger than 90°, generating the third sensing signal.

17. The method of claim 12, wherein the step (c) comprises:
generating the third sensing signal when the designator drags the item on the display area and then ceases moving the item over a predetermined period, the step (d) comprises:
opening the user interface corresponding to the item in the display area.

18. The method of claim 17, wherein the predetermined period is 2 seconds.

19. The method of claim 11, wherein the screen is a touch screen or a non-touch screen.
